(19) United States
(12) Patent Application Publication
(10) Pub. No.: US 2024/0119799 A1
(43) Pub. Date: Apr. 11, 2024

(54) SYSTEM AND METHOD FOR SECURELY ENABLING A SECOND GAME IN A NETWORK OF GAMING MACHINES

(71) Applicant: Lance Lietzau, Columbus, MN (US)

(72) Inventor: Lance Lietzau, Columbus, MN (US)

(21) Appl. No.: 18/198,041

(22) Filed: May 16, 2023

Related U.S. Application Data
(63) Continuation-in-part of application No. 17/864,832, filed on Jul. 14, 2022.
Application No. 17/864,832 is a continuation-in-part of application No. 15/782,445, filed on Oct. 12, 2017, now abandoned.
(60) Provisional application No. 62/561,029, filed on Sep. 20, 2017.

(51) Int. Cl. G07F 17/32

(52) U.S. Cl. CPC G07F 17/3267; G07F 17/3209; G07F 17/3211; G07F 17/3223; G07F 17/323; G07F 17/329

(57) ABSTRACT

Systems and methods for providing a secure second game through a plurality of electronic gaming machines including a controller configured to use the existing network of electronic gaming machines to display a second game wager activation button on the display devices of each electronic gaming machine, detect activation of the second game wager through a display device, deduct credit for wagers in the second game from the credit meter of each electronic gaming machine from which activation is detected, determine a winning electronic gaming machine based on randomly selecting one of the unique identifications for each electronic gaming machine from which activation is detected, and add credit to the credit meter of the winning electronic gaming machine.

### BACKGROUND OF THE INVENTION

The disclosure relates to systems and methods enabling secure game operations, including wagering and random win generation across a plurality of the same or different electronic gaming machines.

### BACKGROUND OF INVENTION

An embodiment of the disclosure meets the needs presented above by generally comprising a plurality of different table games. Each of the table games includes a plurality of player positions. A plurality of interface assemblies is provided and each of the table games has one of the interface assemblies. Each of the interface assemblies is programmed to receive one or more betting units from each of the plurality of player positions and associating the betting units with each player position submitting the betting units. A database is in communication with each of the interface assemblies. The database is programed to tally the betting units and form a pool of the betting units from across the different table games. The database is programmed to randomly select one of the betting units to define a winning bet and communicating the winning bet and the pool to at least the interface assembly positioned on the table game associated with the player position having the winning bet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### SUMMARY OF THE INVENTION

The invention is generally directed to solving issues such as those cited above.

Some embodiment of the invention are directed to systems and methods for securely enabling a second game through a plurality of electronic gaming machines connected in an EGM-managing network, wherein each electronic gaming machine of the plurality of electronic gaming machines is associated with a unique identification code and includes a housing and one or more internal components mounted within the housing being configured to enable play of a first game independently of any other electronic gaming machine connected to the EGM-managing network, the one or more internal components including a touchscreen display device, a memory and a communication interface within the housing, wherein the memory stores player credit and the communication interface receives data signals from the one or more internal components, the data signals including an active session data signal corresponding to an outcome of the first game being undetermined and an inactive session data signal corresponding to an outcome of the first game being determined.

The aforementioned system includes a game transaction controller including a processor, a data communication device, and a data storage device, the data storage device including executable code, wherein the data communication device is in communication with the communication interface, the EGM-managing network and a random number generator, the processor executing the executable code to enable the game transaction server to: responsive to detecting an inactive session data signal, actuate (i) a timer, wherein the timer counts down a preset time period, (ii) and a transmission of a second game display to the communication interface for display on the touchscreen display device, the second game display including the timer and a touch-sensitive portion for wagering on the second game; responsive to detecting a data signal received by the communication interface from the one or more internal components relating to the touch-sensitive portion being touched prior to the end of the preset time period, store the unique identification code from each electronic gaming machine of the plurality of electronic gaming machines from which the data signal is detected in the data storage device with a group of unique identification codes associated with an instance of the second game; transmit a data signal instruction to the EGM-managing network to deduct an amount of credit from the player credit relating to the wager, the data signal instruction including the unique identification code from which the data signal is detected; responsive to validating the wager by detecting a data signal generated by the one or more internal components relating to the amount of credit being deducted, actuate the random number generator to randomly select a winning unique identification code from the group of unique identification codes associated with the instance of the second game; transmit a data signal instruction to the EGM-managing network to credit an award amount to the player credit of the electronic gaming machine having the winning unique identification code, the data signal instruction including the winning unique identification code; display the winning unique identification code and award amount on the second game display; determine a location of the electronic gaming machine having the winning unique identification code through communication with the EGM-managing network; and display the location of the electronic gaming machine having the winning unique identification code on the second game display.

Some embodiments of the invention are directed to an improvement to an electronic casino gaming floor system configured to enable a second game, with the improvement including a game transaction controller including a processor, a data communication device, and a data storage device, the data storage device including executable code, wherein the data communication device is in communication with the communication interface, the EGM-managing network and a random number generator, the processor executing the executable code to enable the game transaction server to: responsive to detecting an inactive session data signal, actuate (i) a timer, wherein the timer counts down a preset time period, (ii) and a transmission of a second game display to the communication interface for display on the touchscreen display device, the second game display including the timer and a touch-sensitive portion for wagering on the second game; responsive to detecting a data signal received by the communication interface from the one or more internal components relating to the touch-sensitive portion being touched prior to the end of the preset time period, store the unique identification code from each electronic gaming machine of the plurality of electronic gaming machines from which the data signal is detected in the data storage device with a group of unique identification codes associated with an instance of the second game; transmit a data signal instruction to the EGM-managing network to deduct an amount of credit from the player credit relating to the wager, the data signal instruction including the unique identification code from which the data signal is detected; responsive to validating the wager by detecting a data signal generated by the one or more internal components relating to the amount of credit being deducted, actuate the random number generator to randomly select a winning unique identification code from the group of unique identification codes associated with the instance of the second game; transmit a data signal instruction to the EGM-managing network to credit an award amount to the player credit of the electronic gaming machine having the winning unique identification code, the data signal instruction including the winning unique identification code; display the winning unique identification code and award amount on the second game display; determine a location of the electronic gaming machine having the winning unique identification code through communication with the EGM-managing network; and display the location of the electronic gaming machine having the winning unique identification code on the second game display.

In some embodiments, the invention is directed to a method and system for securely enabling a second game through a plurality of electronic gaming machines connected in a EGM-managing network, wherein each electronic gaming machine of the plurality of electronic gaming machines is associated with a unique identification code and includes a housing and one or more internal components mounted within the housing being configured to enable play of a first game independently of any other electronic gaming machine connected to the EGM-managing network, the one or more internal components including a touchscreen display device, a memory and a communication interface within the housing, wherein the memory stores player credit and the communication interface receives an active session data signal corresponding to an outcome of the first game being undetermined and an inactive session data signal corresponding to an outcome of the first game being determined, the method and system including a game transaction controller including a processor, a data communication device, and a data storage device, the data storage device including executable code, wherein the data communication device is in communication with the communication interface, the EGM-managing network and a random number generator.

The processor of the aforementioned embodiment executes the executable code to enable the game transaction server to: responsive to detecting an inactive session data signal, actuate (i) a timer, wherein the timer counts down a preset time period, (ii) and a transmission of a second game display to the communication interface for display on the touchscreen display device, the second game display including the timer and a touch-sensitive portion for wagering on the second game; responsive to the communication interface receiving a data signal generated by the one or more internal components relating to a touch being detected on the touch-sensitive portion prior to the end of the preset time period, the data communication device detecting the data signal and recording the unique identification code from each electronic gaming machine of the plurality of electronic gaming machines from which the data signal is detected in the data storage device as a group of unique identification codes associated with an instance of the second game; communicate with the EGM-managing network to deduct an amount of credit from the player credit relating to the wager; actuate the random number generator to randomly select a winning unique identification code from the group of unique identification codes; communicate with the EGM-managing network to credit an award amount to the player credit of the electronic gaming machine having the winning unique identification code; display the winning unique identification code and award amount on the second game display; communicate with the EGM-managing network to determine a location of the electronic gaming machine having the winning unique identification code; an display the location of the electronic gaming machine having the winning unique identification code on the second game display.

In some embodiments, the game transaction server stops the second game display or changes the size of the second game display on the touchscreen display device responsive to detecting the data signal associated with the active session data signal.

In some embodiments, the EGM-managing network includes various elements, such as one or more servers, processors, data storage devices and data communication devices.

In some embodiments, the invention is directed to a system and method for providing a secure second game through a plurality of electronic gaming machines, each electronic gaming machine of the plurality of electronic gaming machines including a display device, the system comprising a game server and a transaction server in communication with the plurality of electronic gaming machines, each of the game server and the transaction server including one or more processors, data communication devices and data storage devices, the one or more data storage devices including an executable program, the one or more processors being configured to execute the executable program to: a) actuate the game server to transmit a second game data for display as a second game display on the display device of each electronic gaming machine of the plurality of electronic gaming machines, wherein the second game data includes a time remaining for placing a wager in an instance of the second game; b) enable the transaction server to receive an indication of a wager being placed in the instance of the second game through the second game display on the display devices of a plurality of electronic gaming machines, wherein the indication of the wager is transmitted to the transaction server by detecting a designated portion of the second game display being touched by a player, and wherein the indication of the wager is transmitted to the transaction server with a plurality of unique identifications for the plurality of electronic gaming machines; c) enable the game server to receive the plurality of unique identifications, communicate with a random number generator to randomly select a unique identification of the plurality of unique identifications, wherein the unique identification selected is the winner of the instance of the second game; and d) the transaction server receiving the unique identification selected and distributing a payout to be displayed on the display device of an electronic gaming machine corresponding to the unique identification.

These features and advantages of the present disclosure may be appreciated by reviewing the following description of the present disclosure, along with the accompanying figures wherein like reference numerals refer to like parts.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a schematic view of a system and method of combining a lottery game and a table game according to an embodiment of the disclosure.

FIG. 2 is a schematic view of a plurality of table games of an embodiment of the disclosure.

FIG. 3 is a front view of an interface assembly of an embodiment of the disclosure.

FIG. 4 is a schematic view of an embodiment of the disclosure.

FIG. 5 is a schematic view of an embodiment of the disclosure.

FIG. 6 is a schematic representation of various examples of gaming systems which may be used with embodiments of the invention.

FIG. 7 is a schematic diagram depicting the components of an exemplary system configured and constructed according to some embodiments of the invention.

FIG. 8 is a process flow chart depicting an exemplary method for conducting a game configured and constructed according to some embodiments of the invention.

FIG. 9 is a perspective view of an individual electronic gaming device configured for implementation of embodiments of games in accordance with this disclosure.

FIGS. 10-14 illustrate exemplary game user interface display screens configured and constructed according to some embodiments of the invention.

### DETAILED DESCRIPTION OF SOME EMBODIMENTS OF THE INVENTION

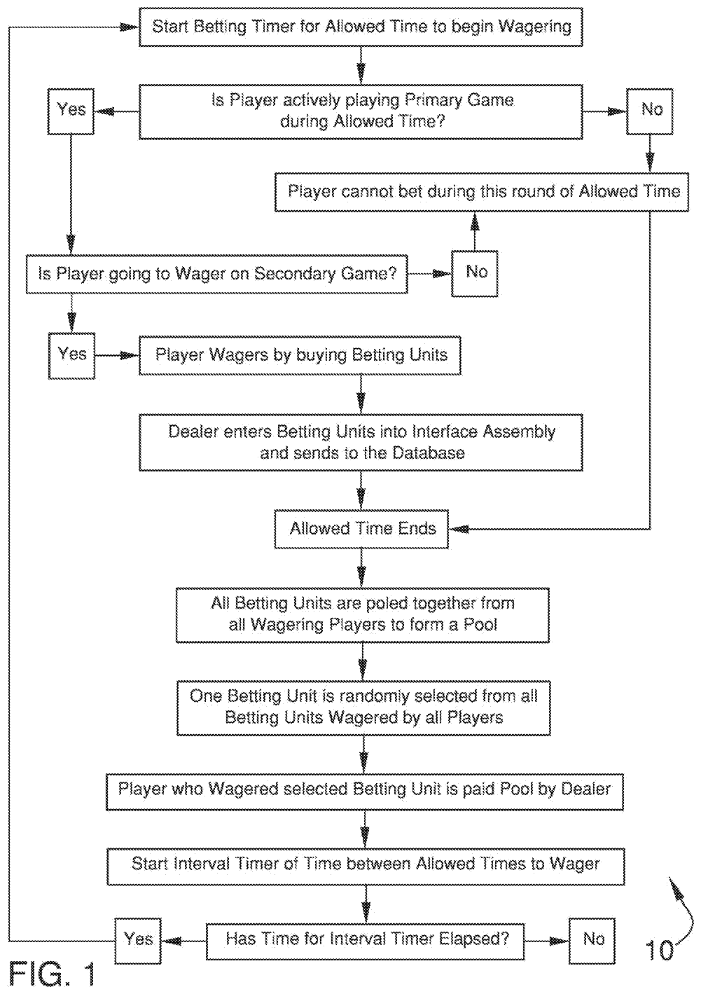

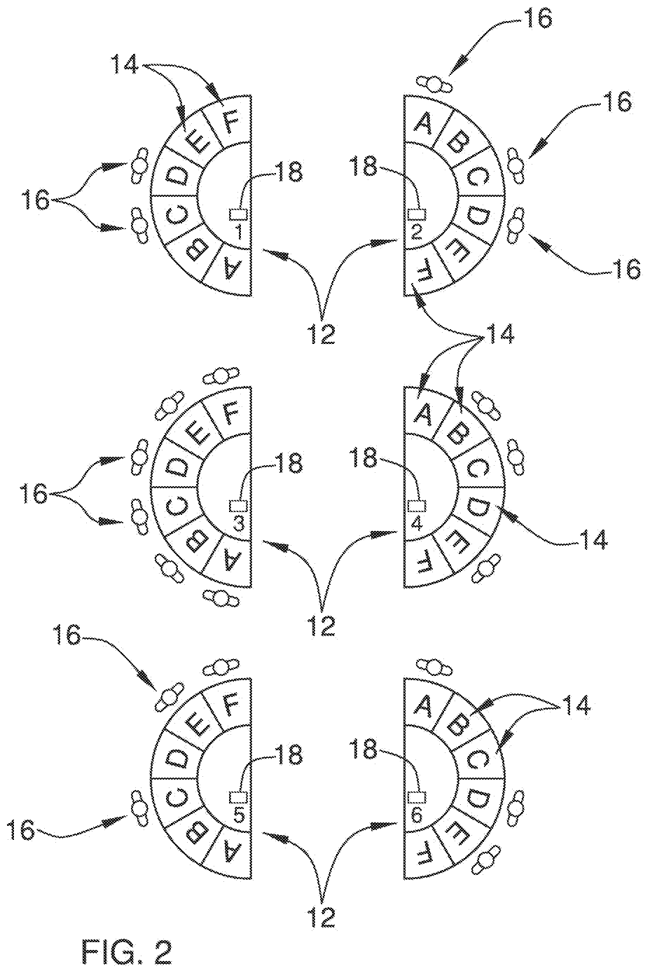

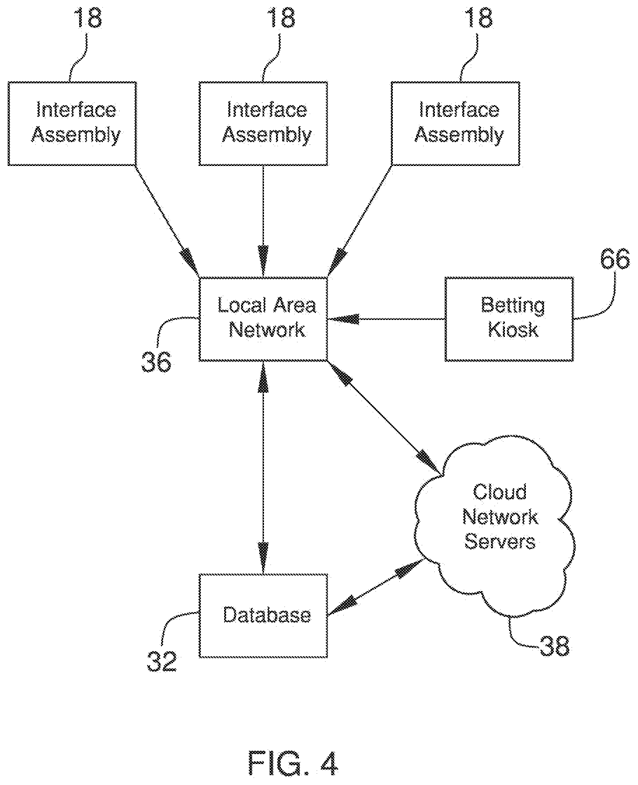

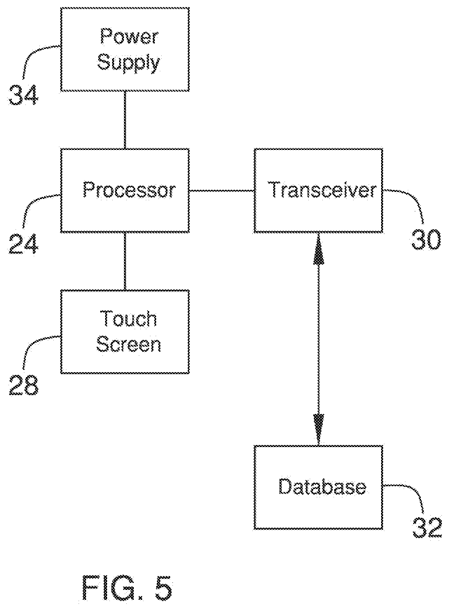

With reference now to the drawings, and in particular to FIGS. 1 through 5 thereof, a new lottery game system embodying the principles and concepts of an embodiment of the disclosure and generally designated by the reference numeral 10 will be described.

As best illustrated in FIGS. 1 through 5, the system 10 and method of combining a lottery game and a table game generally comprises a system 10 that is designed, in particular, to be played with a plurality of table games 12. Table games 12 are ubiquitous in casinos and each typically includes one primary game that is played by players seated at player positions 14. While a single player may utilize a plurality of player positions 14, a lottery game, as discussed herein, is not dependent upon the player position 14 for betting purposes but is simply utilized to locate the player 16 who is the winner of the lottery game. The table games 12 may comprise any number of common casino games including, for example, various card games, roulette, craps, pai gow and the like. However, the system 10 is most typically well suited for those games involving one or more decks of cards such as poker, baccarat, blackjack and the multiple derivatives of those two games. Generally, for the purpose of the system 10, players 16 will typically only be allowed to bet on the lottery game if they are also playing the primary game such that their player position 14 may be defined as an active position wherein they are at least wagering on the primary game which they will play in a conventional manner.

A plurality of interface assemblies 18 is provided and each table game 12 within the overall lottery game will include one of the interface assemblies 18. The interface assemblies 18 are to be used to play a second game, or lottery game, between players who desire to play such while also playing the primary game. The lottery game is generally conventional in that each willing player 16 will buy a desired number of plays within the lottery game. One player 16 may, for instance, buy five plays while the next player 16 only buys 1 play. The more plays a player buys, or wagers, the greater the chance to win. As an example, if a pool contains one hundred plays, and a player 16 buys 10 plays, that player would have a 1 in 10 chance of winning the lottery game. The players 16 will have the option to wager as many plays as they chose (within casino appointed limits) or to not play at all.

The interface assemblies 18 may be embedded into a surface of its associated table game 12 though it may be beneficial to allow the interface assemblies 18 to be detached or detachable from the table games 12 so that they can be moved to different table games 12 as needed. In this manner, while a casino might have forty table games 12, a smaller number of interface assemblies 18 may utilized as not all table games 12 within the casino need be part of the lottery game. Moreover, this will allow a casino floor manager to move the interface assemblies 18 to table games 14 having a higher number of active positions. The interface assemblies 18 may be programmed such that they are assigned to a particular gaming table 12 and that assignation is changed when the interface assembly 18 is moved to a different gaming table 12 so that each interface assembly 18 is always associated with the table game 12 and player positions 14 it is being used with.

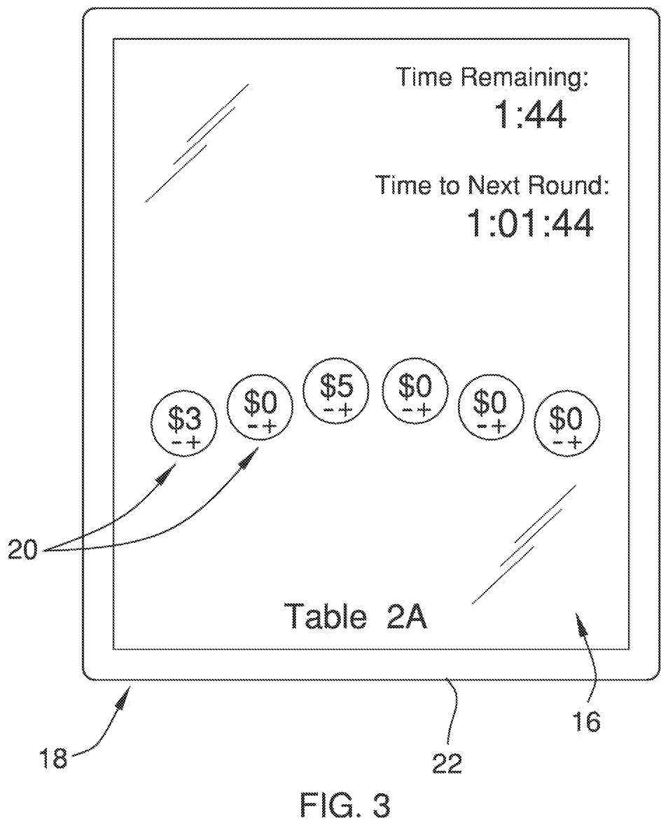

Each of the interface assemblies 18 is programmed to receive one or more betting units from each of the plurality of player positions 14 and associating the betting units with each player position 14 submitting the betting units. As can be seen in FIG. 3, a specific input location 20 may exist for each player position 14. The term “betting units” is being utilized as each betting unit is discrete with respect to each other and are monetarily equal to each other. For example, a single betting unit may be equal to a monetary amount such as $1, $5, $10 and onward. However, the casino may decide to award players 16 who are playing the primary game with betting units in the form of electronic awards or award markers/chips. If the minimum wager for the second game is $1 per play and a player wagers $4, that player 16 will have purchased four betting units. Furthermore, the betting units are each differentiated from each other as each is associated with one of the player positions on the table game 12. Typically, in table games 12, the player's wagers are placed in front of them while gameplay takes place for the primary game. For the second game, and unlike table games 12, the wagers will typically be collected and removed from the table game 12 once placed and therefore the betting units must be tracked when placed. To that end, the interface assemblies 18 associate the betting units with the player positions 14 from which they came.

The interface assemblies 18 will typically include a housing 22 and a processor 24 that is mounted within the housing 22. An input 26 is mounted on the housing 22 and is electrically coupled to the processor 24. The input 26 is actuatable to input a number of the betting units associated with each of the player positions 14 at an associated one of the table games 12. Preferably the input may comprise a touchscreen 28. A touchscreen 28 can be utilized to visually display the number of betting units played by each player 16, the amount the winner player will win as well as the winner bet and the player position 14 associated with the winning bet. The interface assembly 18 may further include a transceiver 30 for wireless communication with other interface assemblies 18 or with a database 32. The transceiver 30 is mounted within the housing 22 and electrically coupled to the processor 24. The interface assembly 18, as described above, may be what is conventionally known as an electronic tablet. A power supply 34 may include a battery mounted within the housing 22 though it is preferred that each table game 12 include a power outlet to ensure power is not lost during gameplay.

The database 32 is in communication with each of the interface assemblies 18. It should be understood that the database 32 may be comprised of one of interface assemblies 18 or may comprise a separate computing assembly that may be positioned within the same casino complex with the interface assemblies 18 or placed offsite and in wired or wireless communication with a server that is in communication with each of the interface assemblies 18. However, when the second game is played, the betting will take place only between those persons located within a same casino complex, i.e. building, to increase the excitement amongst players who are in more intimate proximity with respect to each other. Consequently, while the database 32 may be programmed to receive and process data from a plurality of casino complexes, each casino complex would be handled independently from the other casino complexes by the database 32.

Communication between the database 32 and the interface assemblies 18 may be accomplished in any conventional manner. The database 32 may be wired or wirelessly in communication for local area network (LAN) 36 which is in wireless communication with each of the interface assemblies 18. The interface assemblies 18 may communicate with an internet router, likely by wireless communication that connects with a cloud server network 38. Thereafter the cloud server network 38 may communicate with the database 32, though a wired or wireless router may simply by itself or in connection with the LAN 36 be in communication with the database 32. Thus, the database 32 may be placed most convenient to the operator of the system 10.

The database 32 is programmed to tally the betting units and form a pool of the betting units. The pool is the amount of money that will paid out to the winner of the second game but the pool will typically not be equal to the total number betting units and will instead usually be less than the total of betting units. The casino will determine a percentage that will paid to the winner player and a percentage that will be retained by the casino as profit. The database 32 will be programmed to determine the amount retained. As an example, if a 100 betting units are wagered and each betting unit is $2, the pool may be equal to $180 if the casino retains 10% of wagered bets. The database 32 will also be programmed to calculate retained taxes should a player win a pool that large enough to trigger a taxable event.

The betting units may be assigned a unique identifier by the interface assembly or the database 32, though the betting units may be synonymous with the unique identifier. The unique identifier includes information related to who placed the wager and more specifically the player position 14 or active position. The database 32 is programmed to randomly select one of the betting units, or the unique identifier, to define a winning bet and thereafter communicate the winning bet and the pool to at least the interface assembly positioned on the table game 12 associated with the player position having the winning bet.

Example of Gameplay:

A plurality of players 16 are seated at various table games 12 each having its own input assembly. Each player 16 is also positioned at player position 14 and are wagering on the primary games for their game table 12 so that their player position 16 is an active position that thereby qualifies the player 16 for the second game. At predetermined intervals, the active positions are offered the opportunity to play the second game. The predetermined intervals are typically greater than 30 minutes and less than 3 hours. This will provide for a large number of added game experiences for the players 16 without distracting from the primary game. Furthermore, the presentation to the players 16 to play the second game will last for only a predetermined amount of time which will typically be less than 5 minutes and more particularly less than 3 minutes to again prevent prolonged interference with the primary game. Either the database 32 or the input assemblies 18 may be programmed to track the predetermined intervals and amount of time to place bets. The predetermined intervals and amount of time to place bets may both be readily viewable to the players 16 as a countdown clock that may be displaced on the interface assemblies 18 or displayed remotely from the table games 12 such as a display on a wall or mounted in a conspicuous area where it can be viewed by multiple ones of the table games 12.

During the predetermined amount of time, the dealer of the primary game will accept wagers, defined generally herein as betting units, for the second game. The players 16 essentially are playing against each other in a drawing and the more betting units waged, the greater their chances of winning. The dealer will enter the amount that each player bets so that each player playing this second game will be credited their betting units. The player 16 will be able to pay down to a minimum amount allowed for that particular table game 12 and up a maximum amount allowed for that table game 12. The minimums and maximums may be tied to the minimum and maximums of the primary game but this need not be the case.

After the predetermined amount of time has elapsed, the interface assemblies 18 send the betting unit data to the database 32 which assigns each betting unit its unique identifier, if the betting unit is already itself not the unique identifier, and then randomly selects one of the unique identifiers to define a winning bet. As can be seen in the Figures, the table games 12 may be numbered 1 through 6, each having a player position marked A through F. As a non-limiting example shown in FIG. 3, a player 16 seated at 2A places 3 bets may have betting units having unique identifiers 2A1, 2A2 and 2A3, indicating the player at position 2A has made bets 1, 2 and 3. The database 32 may receive information that from the interface assembly 18 on table 2 that player A has made three bets and thereafter may assign unique identifications that are then back associated to the player 16 should that player win. The above is example only and any conventional manner of assigning a player 16 a particular player position 14 and unique identifier per bet or betting unit may be utilized.

The database 32 also calculates, as stated above, the pool that will be paid out to a winner of the second game. The database 32 transmits the pool amount and winning bet associated therewith and defined as the winning player to the interface assemblies 18 though only the interface assembly 18 associated with the winning player need be sent this information. The pool is then awarded to the winning player by the dealer or automated dealer at the table game 12 hosting the winning player.

Once a winning player is selected, the system 10 resets and the interval time started. Once the interval time has elapsed the dealer will re-open betting players.

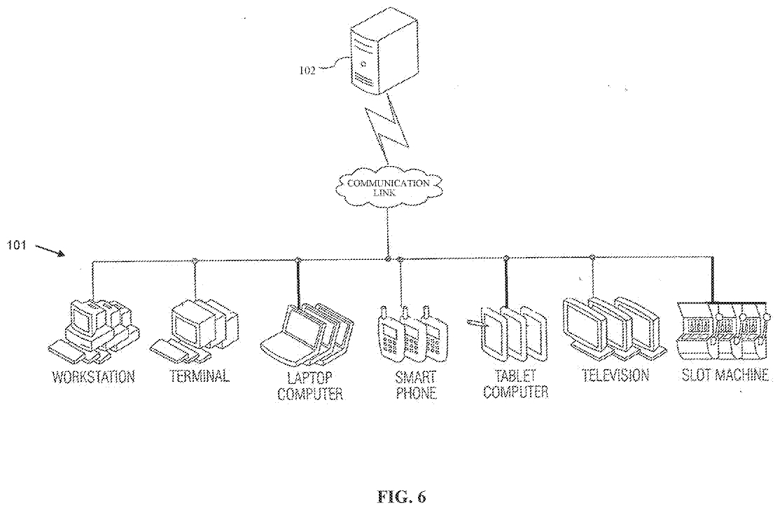

FIG. 6 illustrates a schematic of exemplary gaming system hardware and network platform that can be used to implement embodiments of the invention. The system includes gaming systems such as electronic gaming machines (“EGMs”) and plurality of personal computing devices, all of which are in communication with the same or different one or more central servers 102 through one or more communication links, which may include a data networks and the internet. Exemplary personal computing devices shown in FIG. 6 include workstations, terminals (including self-service wagering terminals), laptops or other internet connected computing systems, mobile or smart phones, tablet computers and televisions. For brevity and clarity, unless specifically stated otherwise, an EGM as used herein represents one EGM or a plurality of EGMs, and a central server, central controller, or remote host as used herein represents one central server, central controller, or remote host or a plurality of central servers, central controllers, or remote hosts. Thus, the EGMs shown in FIG. 1 are generally designated by the reference numeral 101.

It should be understood that some gaming systems, and EGMs or gaming machines within gaming systems, are implemented with special features and/or additional circuitry that differentiates them from general-purpose computers (e.g., desktop PC's and laptops). EGMs are highly regulated to ensure fairness and, in many cases, EGMs are operable to dispense substantial monetary awards. Therefore, to satisfy security and regulatory requirements in a gaming environment, hardware and software architectures may be implemented in gaming machines that differ significantly from those of general-purpose computers. A description of EGMs relative to general-purpose computing machines and some examples of the additional or different components and features found in gaming machines are described below.

Though both personal computers, or personal computing devices as the term is used herein, and gaming machines employ microprocessors that control a variety of devices, adapting technology used in personal computers to a gaming machine can be quite difficult because of reasons such as the regulatory requirements that are placed upon gaming machines, the harsh environment in which gaming machines operate, security requirements and fault tolerance requirements. Further, techniques and methods for solving a problem in the computer industry, such as device compatibility and connectivity issues, might not be adequate in the gaming environment. For instance, a fault or a weakness tolerated in a personal computer, such as security holes in software or even frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between personal computer devices and gaming systems will be described. A first difference between gaming machines and common personal computer devices and systems based on personal computer devices is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and then before the award could be provided to the player the power failed, the gaming machine, upon the restoration of power, would return to the state where the award is indicated. The need to provide a state-based system affects the software and hardware design on a gaming machine.

A second important difference between gaming machines and common personal computer devices or personal computer-based systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common personal computer devices and personal computer-based systems is the number and kinds of peripheral devices used on a gaming machine are not as great as on personal computer-based computer systems. Traditionally, in the gaming industry, gaming machines have been relatively simple in the sense that the number of peripheral devices and the number of functions the gaming machine has been limited. Further, in operation, the functionality of gaming machines are relatively constant once the gaming machine was deployed, and new peripherals devices and new gaming software are infrequently added to the gaming machine. This differs from a personal computer where users often buy different combinations of devices and software from different manufacturers and connect them to a computer to suit their needs. Therefore, the types of devices connected to a personal computer may vary greatly from user to user depending in their individual requirements and may vary significantly over time.

Although the variety of devices available for a personal computer may be greater than on a gaming machine, gaming machines still have unique device requirements that differ from a personal computer, such as device security requirements not usually addressed by personal computers. For instance, monetary devices, such as coin dispensers, bill validators and ticket printers and computing devices that are used to govern player accounts, credit and debit player account balances and handle the input and output of cash to a gaming machine have security requirements that are not typically addressed in personal computers. Therefore, many personal computer techniques and methods developed to facilitate device connectivity and device compatibility do not address the emphasis placed on security in the gaming industry.

The foregoing notwithstanding, features of the invention may be implemented on both gaming machines and personal computing devices or other devices which are not specially configured for the provision of a wagering game and therefore may lack components typically included in gaming machines. Accordingly, a gaming system as used herein refers to any and all of the foregoing machines and devices, including various configurations that may include one or more central servers, central controllers, or remote hosts, one or more electronic gaming machines and/or one or more devices which are not specially configured for the provision of a wagering game, such as desktop computers, laptop computers, tablet computers or computing devices, televisions, personal digital assistants (PDAs), mobile telephones such as smart phones, and other mobile computing devices, all of which are collectively referred to by the term personal computing devices used herein.

Thus, in various embodiments, the gaming system of the present disclosure may include: one or more electronic gaming machines in combination with one or more central servers, central controllers, or remote hosts; one or more personal computing devices in combination with one or more central servers, central controllers, or remote hosts; one or more personal computing devices in combination with one or more electronic gaming machines; one or more personal computing devices, one or more electronic gaming machines, and one or more central servers, central controllers, or remote hosts in combination with one another; a single electronic gaming machine; a plurality of electronic gaming machines in combination with one another; a single personal computing device; a plurality of personal computing devices in combination with one another; a single central server, central controller, or remote host; and/or a plurality of central servers, central controllers, or remote hosts in combination with one another. In the various embodiments, the personal computing devices and/or electronic gaming machines are configured to communicate with one another and/or the central server, central controller or remote host through a communication link, such as a local or wide area data network, closed, intranet or open system or remote link such as the Internet.

In certain embodiments in which the gaming system includes an EGM in combination with a central server, central controller, or remote host, the central server, central controller, or remote host is any suitable computing device (such as a server) that includes at least one processor and at least one memory device or storage device. As further described below, the EGM includes at least one EGM processor configured to transmit and receive data or signals representing events, messages, commands, or any other suitable information between the EGM and the central server, central controller, or remote host. The at least one processor of that EGM is configured to execute the events, messages, or commands represented by such data or signals in conjunction with the operation of the EGM. Moreover, the at least one processor of the central server, central controller, or remote host is configured to transmit and receive data or signals representing events, messages, commands, or any other suitable information between the central server, central controller, or remote host and the EGM. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the EGM. It should be further appreciated that one, more, or each of the functions of the at least one processor of the EGM may be performed by the at least one processor of the central server, central controller, or remote host.

In certain such embodiments, computerized instructions for controlling any games (such as any primary or base games, any secondary or bonus games and/or any non-primary and non-secondary games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs are implemented in a thin client environment, and certain other functions of one or more of the EGMs are implemented in a thick client environment. In one such embodiment in which the gaming system includes an EGM and a central server, central controller, or remote host, computerized instructions for controlling any primary or base games displayed by the EGM are communicated from the central server, central controller, or remote host to the EGM in a thick client configuration, and computerized instructions for controlling any secondary or bonus games or other functions displayed by the EGM are executed by the central server, central controller, or remote host in a thin client configuration.

In certain embodiments in which the gaming system includes: an EGM configured to communicate with a central server, central controller, or remote host through a data network; and/or a plurality of EGMs configured to communicate with one another through a data network, the data network is a local area network (LAN) in which the EGMs are located substantially proximate to one another and/or the central server, central controller, or remote host. In one example, the EGMs and the central server, central controller, or remote host are located in a gaming establishment or a portion of a gaming establishment.

In other embodiments in which the gaming system includes: an EGM configured to communicate with a central server, central controller, or remote host through a data network; and/or a plurality of EGMs configured to communicate with one another through a data network, the data network is a wide area network (WAN) in which one or more of the EGMs are not necessarily located substantially proximate to another one of the EGMs and/or the central server, central controller, or remote host. For example, one or more of the EGMs are located: in an area of a gaming establishment different from an area of the gaming establishment in which the central server, central controller, or remote host is located; or in a gaming establishment different from the gaming establishment in which the central server, central controller, or remote host is located. In another example, the central server, central controller, or remote host is not located within a gaming establishment in which the EGMs are located. It should be appreciated that in certain embodiments in which the data network is a WAN, the gaming system includes a central server, central controller, or remote host and an EGM each located in a different gaming establishment in a same geographic area, such as a same city or a same state. It should be appreciated that gaming systems in which the data network is a WAN are substantially identical to gaming systems in which the data network is a LAN, though the quantity of EGMs in such gaming systems may vary relative to one another.

In further embodiments in which the gaming system includes: an EGM configured to communicate with a central server, central controller, or remote host through a data network; and/or a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the communication link, data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In various embodiments, an EGM includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASIC s).

As generally noted above, the at least one processor of the EGM is configured to communicate with, configured to access, and configured to exchange signals with at least one memory device or data storage device. In various embodiments, the at least one memory device of the EGM includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). It should be appreciated that any other suitable magnetic, optical, and/or semiconductor memory may operate in conjunction with the EGM disclosed herein. In certain embodiments, the at least one processor of the EGM and the at least one memory device of the EGM both reside within a cabinet of the EGM. In other embodiments, at least one of the at least one processor of the EGM and the at least one memory device of the EGM reside outside the cabinet of the EGM

In certain embodiments, as generally described herein, the at least one memory device of the EGM stores program code and instructions executable by the at least one processor of the EGM to control the EGM. The at least one memory device of the EGM also stores other operating data, such as image data, event data, input data, random number generators (RNGs) or pseudo-RNGs, paytable data or information, and/or applicable game rules that relate to the play of one or more games on the EGM (such as primary or base games, secondary or bonus games and any non-primary and non-secondary games as described below). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an internet or intranet).

In various embodiments, the EGM includes one or more input devices. The input devices may include any suitable device that enables an input signal to be produced and received by the at least one processor of the EGM. One input device of the EGM may be a payment device configured to communicate with the at least one processor of the EGM to fund the EGM or a player account which is capable of funding the EGM. In certain embodiments, the payment device includes one or more of: a bill acceptor into which paper money is inserted to fund the EGM; a ticket acceptor into which a ticket or a voucher is inserted to fund the EGM; a coin slot into which coins or tokens are inserted to fund the EGM; a reader or a validator for credit cards, debit cards, or credit slips into which a credit card, debit card, or credit slip is inserted to fund the EGM; a player identification card reader into which a player identification card is inserted to fund the EGM; through communication with a bank account or mobile device, such as a smartphone, or other account configured for transferring funds or cryptocurrency to the EGM upon authorization by a player; or any suitable combination thereof.

In one embodiment, the EGM includes a payment device configured to enable the EGM to be funded via an electronic funds transfer, such as a transfer of funds from a bank account. In another embodiment, the EGM includes a payment device configured to communicate with a mobile device of a player, such as a cell phone, a radio frequency identification tag, or any other suitable wired or wireless device, to retrieve relevant information associated with that player to fund the EGM. It should be appreciated that when the EGM is funded, the at least one processor determines the amount of funds entered and displays the corresponding amount on a credit display or any other suitable display.

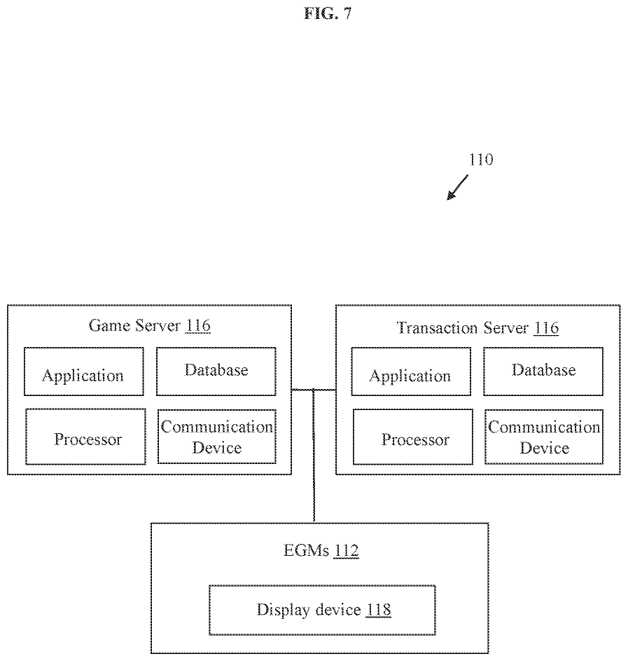

An exemplary embodiment of the system of the invention is shown in FIG. 7 and generally referred to be the reference numeral 110. System 110 may comprise a casino gaming floor having a plurality of gaming devices connected in a network for EGM management referred to generally as a casino management system.

System 110 includes a plurality of EGMs 112 in communication with a game server 114 and a transactional server 116, which may be in further communication with a casino management system (not shown), each of which may include or be associated with one or more data storage devices or databases, data processing devices and data communication devices, among other hardware and software applications configured and adapted to provide and operate the second game of the invention within a gaming system.

It should be understood that game server 114 and transaction server 116 in some embodiments are collectively included a game transaction controller or server having dedicated and/or multi-functional hardware, such as data processing devices and data communication devices, which may perform some or all tasks set forth herein with respect to game server 114 and transaction server 116. However, the description below is relevant to such embodiments for illustrating features and capabilities of such a game transaction controller.

EGMs 112 are generally configured to provide a primary or first game typically installed in memory within the EGM 112 and operated by on board components. EGM 112 may communicate externally with servers 114 and 116 (as well as a casino management system) through a Slot Machine Interface Board (“SMIB”) or other printed circuit board or device which handles internal communications between components of EGM 112, which may be in a code such as Slot Accounting System (“SAS”) protocol, and between EGM 112 and an external network. For example, servers 114 and/or 116 may include a communication link with a communication interface or communication port in EGM 112, which may be established by data communication devices in communication with a port such as an RS232, RS422 or RS485 port in the EGM 112. The communication link established by servers 114 and/or 116 may be capable of detecting communication in the form of data signals such as SAS protocol data signals which are generated by components within EGM 112 as a result of normal user-initiated activity, such as using a bill validator, starting a first game, depressing buttons, coin in, screen touch or other indication of entry by the EGM into a pre-game start mode for a first game or during an active instance of a first game. In some embodiments, the servers 114 and/or 116 are connected so that the communication link detects internal communication within the EGM 112 while not impacting such communications, that is, servers 114 and/or 116 are detecting or receiving data passively without transmitting data or otherwise affecting the communications detected.

Game server 114 is configured to transmit second game data to be displayed on a display device 118 associated with each EGM 112. The display device may be the main EGM display, that is, where the first game installed in the EGM is displayed, or a separate display device also associated with the EGM, such as a display device used by players to access a player account stored in a casino database.

Players may access the second game through display device 118 acting as a user interface, such as in instances where display device 118 is a touch screen display device, or through another user interface associated with each EGM 112, such as a user interface presented on another display device or a button panel.

The second game may be presented on display device 118 in a position or in a manner which does not change the display of the first game. For example, the second game may be accessed through a menu whereby the display on display device 118 changes from displaying the first game to displaying the second game. In another example, a window displaying the second game is displayed on display device 118 in a position or in a manner which does not change the display of first game. In yet another example, second game data is displayed as a transparent image or overlay such that the second game appears in front of the first game. In other embodiments, the display of the first game on display device 118 is adjusted to create an area for the display of the second game therein, such as along the upper border of display device 118.

In some embodiments, game server 114 is configured to transmit second game data to be displayed on EGM 112 responsive to detecting via the EGM's internal communications, such as SAS protocol, that the first game or a first game session is not active, that is, the first game is not currently being played or has otherwise been resolved and ceases to be active.

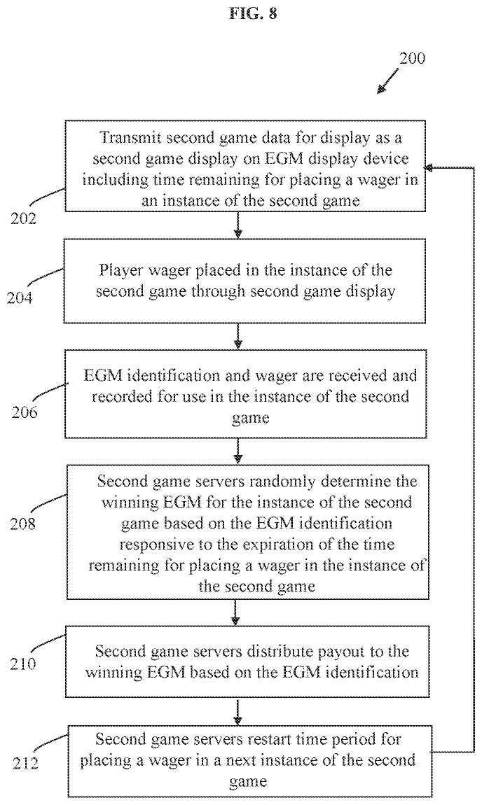

FIG. 8 provides an exemplary operative method of system 110 generally referenced by numeral 200, which may also be represented by a set of instructions stored in one or more memories and executed by one or more processors associated with one or both of game server 114 and/or transaction server 116 in communication with one or more random number generators.

In block 202 of method 200, game server 114 transmits second game data to EGMs 112. Second game data transmitted by game server 114 may include information about the second game, such as game play rules, prior game results and timing for the next or current instance of a second game. Game server 114 may display historical results of the second game, such as the one or more instances in which each particular EGM 112 was selected as a winner in the second game.

As shown in block 204, player interaction with the second game display, such as, selecting to submit a wager in the second game through display device 118, is communicated to transaction server 116 along with an identification of the particular EGM 112 from which the communication is transmitted. Transaction server 116 receives the communication from EGM 112, records the wager and EGM identification information for the EGM 112 from which a wager is received, and communicates the EGM identification for each EGM 112 to game server 114.

In some embodiments, wagers are placed in the second game by using credit stored on the EGM 112, that is, EGM 112 is configured to deduct credit for use in the second game that is added to and stored in memory temporarily on the EGM 112 for use in the first game. In other embodiments, a separate credit or currency must be inputted on EGM 112 for being used to place wagers in the second game through EGM 112. In other embodiments, player loyalty points may be used to transmit a wager for the second game. It should be understood that players may add currency or credit to the EGM 112 by any conventional means, such as through a currency or ticket reading device associated with the EGM.

As shown by block 208, when the time remaining to submit a wager has expired, game server 114 determines the game results for the instance of the second game, which may be in association with a random number generator, by randomly selecting one or more EGM identifications as winners of the instance of the second game.

As shown by block 210, game server 114 communicates the one or more winning EGM identifications to transaction server 118 and transaction server 118 distributes payouts to the one or more winners by communicating with the one or more EGMs 112 corresponding to the randomly selected EGM identification. In some embodiments, game server 114 also communicates the game results to EGMs 112. As shown by block 212, the time period restarts for placing a wager in the next instance of the second game which is displayed by the timer in the second game display according to block 202.

In some embodiments, transaction server 118 distributed payouts by being configured to add credit to the credit meter of the EGM 112. In other embodiments, such as where loyalty points are used, transaction server 118 accesses the player loyalty account (which may require players to initially log in to their player loyalty account on an EGM 112 prior to playing the second game) and adds loyalty points thereto. In yet other embodiments, winners of the second game may receive a payout distribution through a separate source. It should be understood that deducting and crediting the credit meter of EGM 112 may involve system 110 communicating or instructing a casino management system or other network used for managing EGM 112 to deduct and/or add credit to the credit meter of EGM 112 using the EGM identification. System 110 may also validate operations of the casino management system, such as the deducting of credit, by detecting data signals communication associated with such operations. System 110 may stop and/or provide an alert if such data signals are not detected and validated.

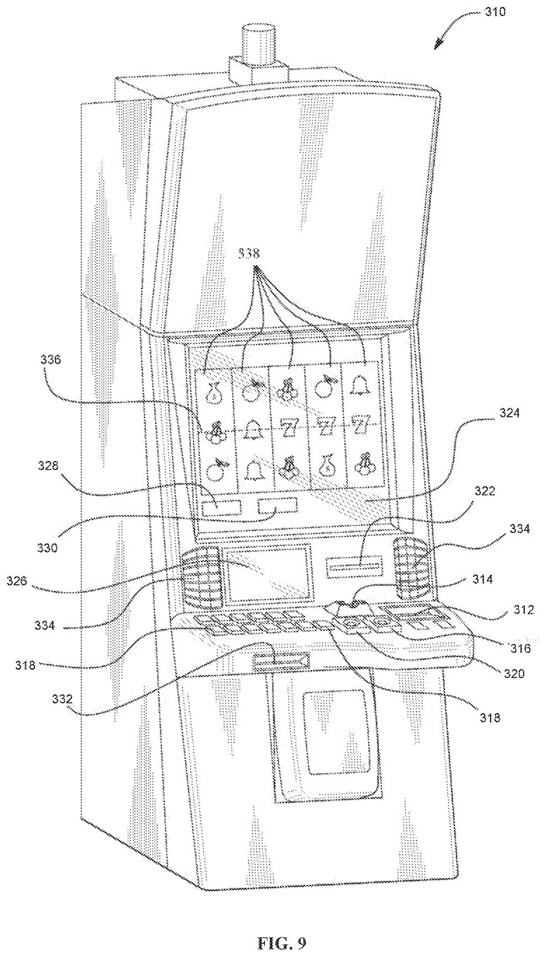

FIG. 9 is a perspective view of an individual electronic gaming device or EGM 310 configured for implementing games, such as a first game and second game according to some embodiments of the invention.

EGM 310 includes one or more input devices used to add credit and initiate a play of a first game on the EGM. EGM 310 includes payment and/or cash-out devices including a combined bill and ticket acceptor 312, and a coin slot 314, for adding credit and receiving tickets as part of a ticket in/ticket out cashless payment system. EGM 310 further includes a game play activation device in the form of a game play actuation button 316 and button panel or buttons 318 consisting of various depressible buttons or touch sensors for selectively playing and wagering in the first and/or second game. A button 320 may be used to cash-out remaining credits as a ticket via ticket printer 332.

EGM 310 also includes and is connected to a casino management system for, among other things, enabling player tracking and access to a player loyalty system. EGM 310 includes a card reader 322 in communication with the at least one processor of the EGM which is configured to read a player identification card inserted into the card reader and communicate with a player loyalty database through the casino management system.

EGM 310 also includes a central display device 324 which may be a touch-screen display coupled to a touch-screen controller within EGM 310 or other touch-sensitive display overlay to enable interaction with any images displayed on central display device 324. For example, central display device 324 may present a conventional touch-screen button panel thereon by the touch-screen and the touch-screen controller being connected to a video controller within EGM 310. In this embodiment, signals are input to EGM 310 by touching the touch screen of central display device 324 at the appropriate locations which may provide the same options as any or all of buttons 316, 318 and 320.

EGM 310 includes a secondary display device 326 which may be used to access the casino player loyalty system or casino resort information. In some embodiments, players may play the second game using central display device 324 whereas in some embodiments players may play the second game through secondary display device 326. In other embodiments, players may select the display to use for the second game.

In this embodiment, EGM 310, a second game timer 328 and touch-sensitive second game wagering button 330 are displayed on central display device 324. Second game timer 328 indicates the time until the next instance of the second game is played. A player touching second game wager button 330 automatically places a wager in the second game, which can be deducted from credit added to the machine through any of bill and ticket acceptor 312 and coin slot 314. In some embodiments, timer 328 is presented as a countdown, and timer 328 and/or wager button 330 may include viewable changes that attract attention during the countdown, such as flashing, highlighting or changing color. In some embodiments, EGM 310 may also attract attention to the second game by generating sound through EGM speakers 334. It should be understood that timer 328 and wager button 330 for the second game may be alternatively displayed in secondary display device 326.

EGM 310 has a support structure, housing or cabinet 336 that provides support for the plurality of the input and output devices such as those mentioned above, and include internal components such as a SMIB, one or more processing devices, executable programs, controllers and memory. Further, the EGM is configured such that a player may operate it while standing or sitting. In various embodiments, the EGM is positioned on a base or stand, or is configured as a pub-style tabletop game (not shown) that a player may operate typically while sitting. EGMs may have varying cabinet and display configurations for playing a primary or first game such as the slot-style game 338 depicted by EGM 310.

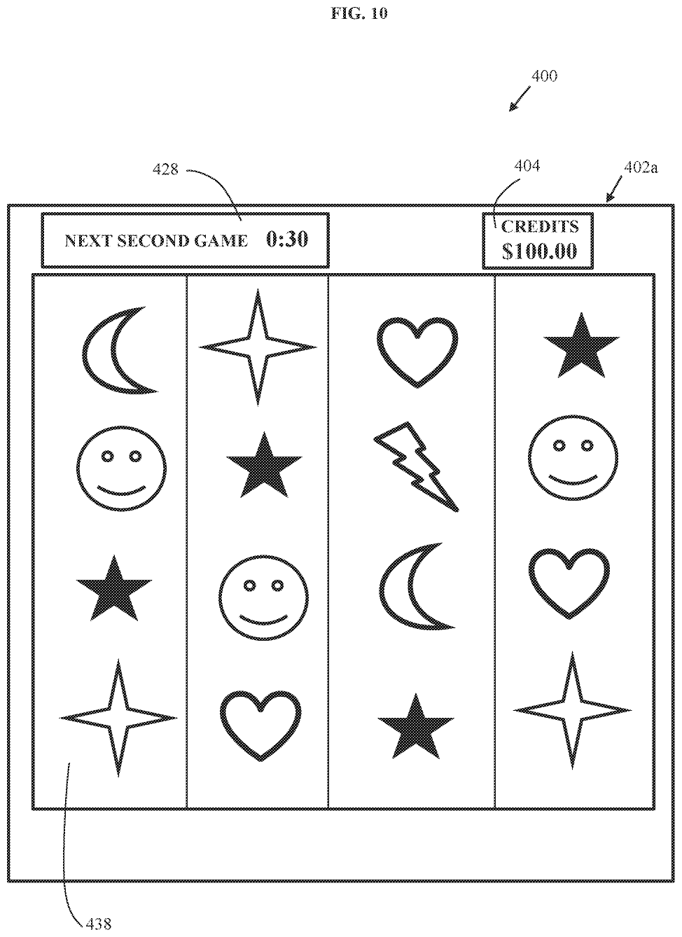

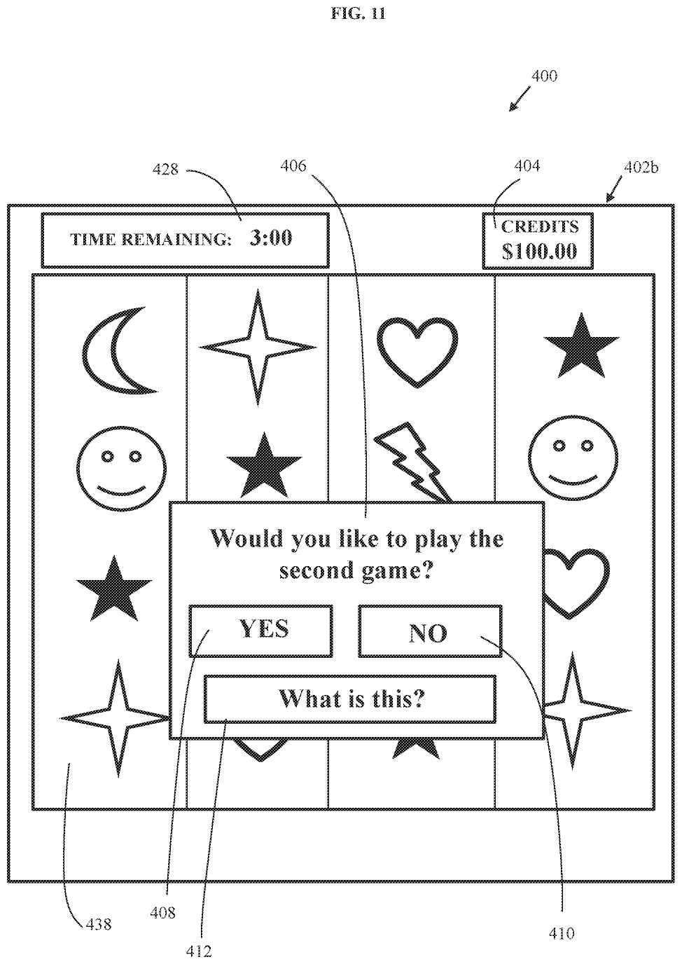

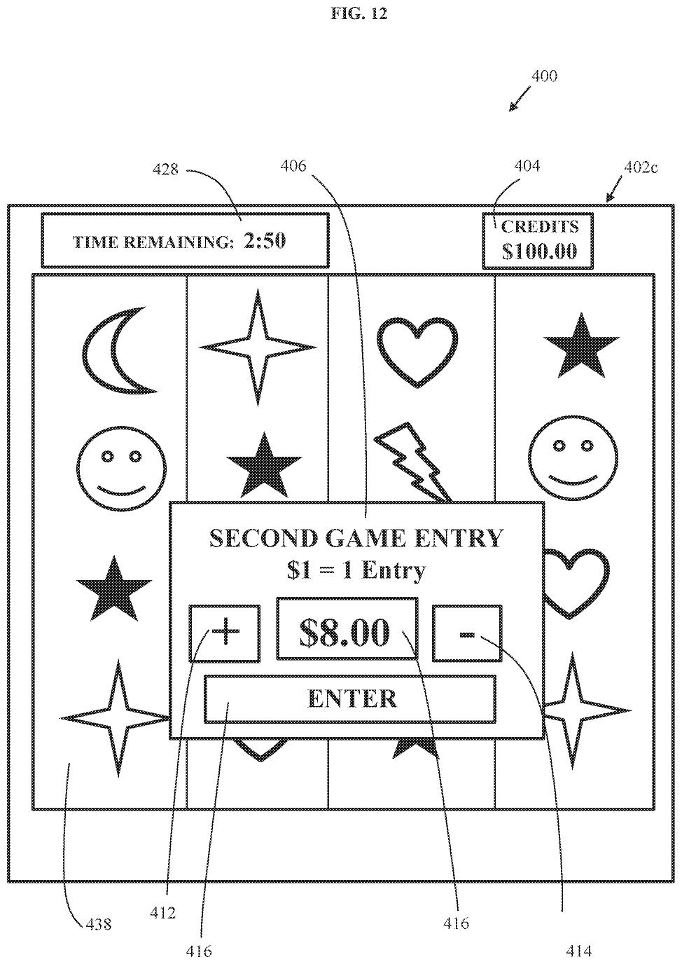

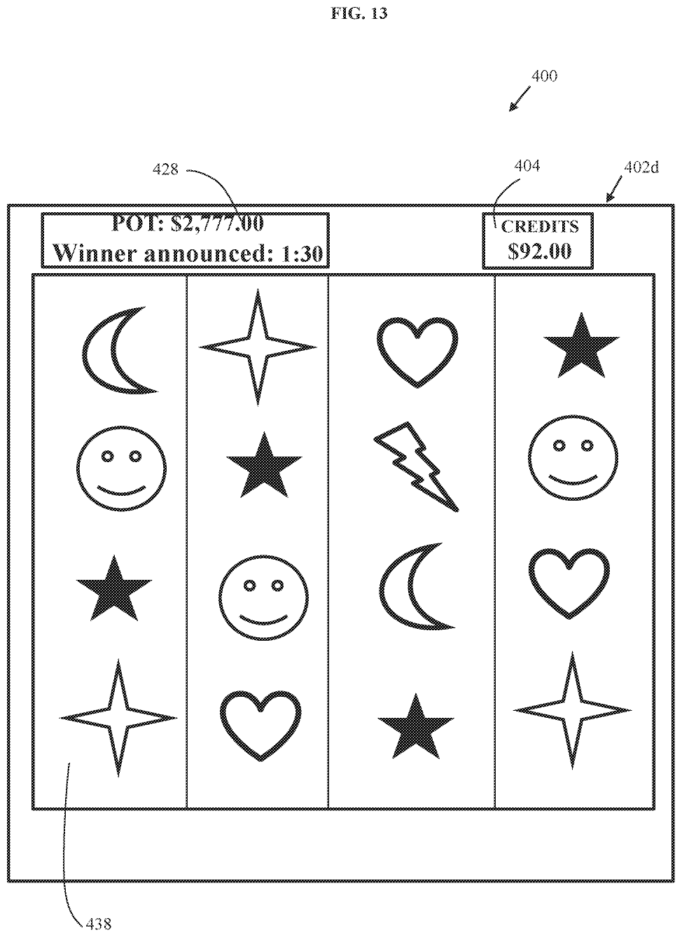

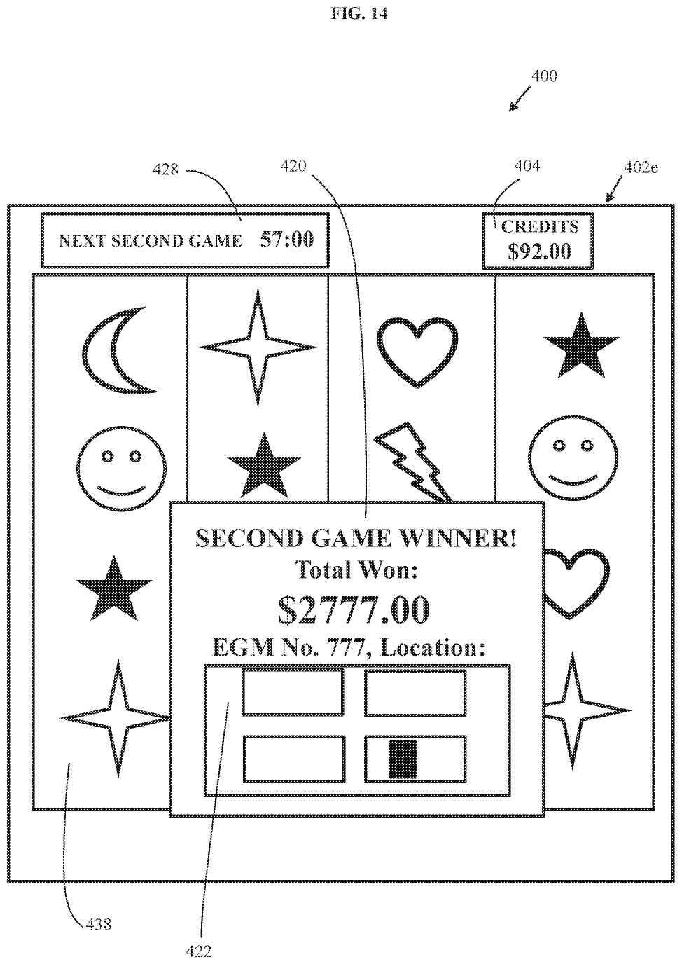

FIGS. 10-14 illustrate a game user interface 400 configured according to some embodiments of the invention for display as a screen on a display device 424 operatively associated with an EGM, such as central display device 324 of EGM 310. It should be understood that game user interface 400 may be configured for use on any gaming system or EGM including any of the devices shown in FIG. 6.

Game user interface 400 displays a game screen 402a illustrating a first game 438. In this embodiment first game 438 is depicted as a slot-style game. It should be understood that first game 438 may be any game that is unrelated to the second game. A credit meter display field 404 indicates the amount of credit currently available on the EGM. The credit displayed by field 404 may have been added to the EGM through devices such as the ticket acceptor 312 of EGM 310.

A field 428 is displayed on game user interface 400 to provide the status of the second game. As shown in FIG. 10, the time remaining displayed in field 428 of FIG. 10 indicates the time remaining until wagering in the second game is enabled, which in screen 402a is depicted as thirty seconds.

As shown by game screen 402b, responsive to the timer indicating that the second game is ready to be played (that is, the time period expiring between instances of the second game such that a new instance of a second game becomes available upon the timer reaching 0:00), a “popup” field 406 is displayed over first game 438 querying whether the player would like to participate in the second game.

As discussed above, popup field 406 may be controlled by a game server, such as game server 114, which is in communication with the EGM SMIB or other internal components and configured to detect SAS protocol or other internal communication that is indicative of an instance of the first game being active. In such embodiments, the game server will restrict the display of popup field 406 while the first game is active, and thereafter display popup field 406 responsive to detecting the instance of the first game being inactive, that is, upon an outcome being determined for the instance of play of the first game. Thus, popup field 406 will not appear in an area or in a manner that obstructs a player's view of the first game while, for example, the reels are spinning in the first game. In some embodiments, field 428 may change to attract attention, such as by highlighting, flashing or displaying a message, responsive to detecting an instance of the first game being active and until the instance of the first game is inactive. Field 428 may also include a timer indicating the time remaining for a player to participate in the current instance of the second game, that is, the time remaining to submit a wager. As an example, field 428 of screen 402b shows three minutes remaining. The timer may remain in place in field 428 and continue to run until a selection is made as discussed below.

As shown, popup field 406 queries whether the player would like to participate in the second game and includes an actuatable button 408 which can be touched to participate in the second game, an actuatable button 410 to decline to participate, and an actuatable button 412 which can be touched to provide a display field for information about the second game. Should the player touch button 410, the game server ceases display of field 406. The game server may instruct or otherwise restrict the EGM from enabling a new instance of the first game from being activated by a player until button 410 is actuated or a wager is placed or confirmed subsequent to pressing button 408. In some embodiments, activating the first game automatically results in game server ceasing the display of field 406 and is recorded by a server, such as transaction server 116 of EGM 110, as a selection to decline to participate. Field 428 may revert to displaying the time until the next available second game responsive to receiving a selection to decline to participate in the current instance of the second game.

As shown in display screen 402c, responsive to a player selecting button 408, a popup field 414 is displayed enabling a player to select the amount wagered or entries for the second game. In this embodiment, each entry is $1.00, and the amount of entries in the second game may be adjusted by either increasing the amount to be wagered using button 412 or decreasing the amount to be wagered using button 414 in one dollar increments. The wagered amount is shown in field 416 and may start initially at one entry but changes upon each adjustment using buttons 412 and 414. The entry is submitted and wager placed upon touching “enter” button 418. The amount wagered is deducted from the credit shown in field 404 as shown in display screen 402d.

In some embodiments, the entry or wager amount is fixed, that is, cannot be changed, such as $5.00 per entry, and thus selecting button 408 would result in the fixed amount being deducted from the credit shown in field 404. In some embodiments, a confirmation or enter button is displayed to confirm the placing of a fixed wager in the second game.

As shown in display screen 402d, popup fields 406 and 414 cease to be displayed, and the transaction server in communication with the EGM and game server, has recorded the selection of the player at the EGM to participate in the current instance of the second game along with an identification of the EGM, collected the amount deducted from credit shown in field 404 as a wager in the current instance of the second game and added the amount deducted, or a portion thereof, to the second game pool for the current instance of the second game. Field 428 now displays the total pool available to be won in the current instance of the second game and a timer until the winner is announced. The timer shown in field 428 may also correspond to the time by which all entry wagers must be placed by other players through other EGMs in order to participate in the current instance of the second game. Thus, the total pool available to be won may change until the timer by which all wagers must be placed reaches zero.

Display screen 402e provides a second game outcome popup field 420 with the results of the current instance of the second game. Field 420 displays an EGM identification from which the winning entry was submitted and the amount won which is distributed by the transaction server. In some embodiments, the winning EGM is identified by the installed first game. In this embodiment, transaction server communicates with the casino management system to determine the location on the gaming floor of the winning EGM based on the EGM identification. The transaction server then facilitates the display of the EGM bank location and/or by a map of the gaming floor showing the location of the EGM. In this embodiment, a map showing the location of the EGM is depicted in field 422.

In some embodiments, the second game is provided in designated intervals, such as every hour, with a set amount of time to participate, such as three or five minutes.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

In some embodiments, the methods, systems, and media disclosed herein include at least one computer program or use of the same. A computer program includes a sequence of instructions, executable in the digital processing device's CPU, written to perform a specified task. Computer-readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer-readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or whole, one or more web applications, one or more mobile applications, one or more standalone applications, one or more web browser plug-ins, extensions, add-ins, or add-ons, or combinations thereof.

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object-oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™ JavaServer Pages (JSP), Hypertext Preprocessor (PHP), Python™, Ruby, Tcl, Smalltalk, WebDNA®, Node, React, Redux or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the methods, systems, and media disclosed herein include one or more databases or use of the same. In view of the disclosure provided herein, those of skill in the art will recognize that many databases are suitable for storage and retrieval of player and game information. In various embodiments, suitable databases include, by way of non-limiting examples, relational databases, non-relational databases, object-oriented databases, object databases, entity-relationship model databases, associative databases, and XML, databases. In some embodiments, a database is internet-based. In further embodiments, a database is web-based.

In still further embodiments, a database is cloud computing-based. In other embodiments, a database is based on one or more local computer storage devices.

A controller, computing device, or computer, such as described herein, may include at least one or more processors or processing units and a system memory. The controller typically also includes at least some form of computer-readable media. By way of example and not limitation, computer-readable media may include computer storage media and communication media. Computer storage media may include volatile and nonvolatile, removable and non-removable media implemented in any method or technology that enables storage of information, such as computer-readable instructions, data structures, program modules, or other data. Communication media typically embody computer-readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer-readable media.

In some embodiments, a controller may include a processor, which as described herein, includes any programmable system including systems and microcontrollers, reduced instruction set circuits (RISC), application-specific integrated circuits (ASIC), programmable logic circuits (PLC), and any other circuit or processor capable of executing the functions described herein. The above examples are exemplary only and thus are not intended to limit in any way the definition and/or meaning of the term processor.

The order of execution or performance of the operations in the embodiments of the invention illustrated and described herein is not essential unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

This written description uses examples to disclose the invention and also to enable any person skilled in the art to practice the invention, including making and using any devices or systems and performing any incorporated methods. The patentable scope of the invention is defined by the claims and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing system or device. Systems of the invention may include the various computer and network-related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt, and processing of data through conventional hardware and/or software technology to effectuate the steps as described herein. Those skilled in the art will further appreciate that the precise types of software and hardware used are not vital to the full implementation of the methods of the invention so long as users, content providers, and operators thereof are provided with useful access thereto, either through a mobile device, system, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

While exemplary apparatus, systems, and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting the scope of the invention in any way. Accordingly, the invention embraces alternatives, modifications, and variations which fall within the spirit and scope of the invention as set forth herein, in the claims and any equivalents thereto.

I claim:

1. A system for securely enabling a second game through a plurality of electronic gaming machines connected in an EGM-managing network, wherein each electronic gaming machine of the plurality of electronic gaming machines is associated with a unique identification code and includes a housing and one or more internal components mounted within the housing being configured to enable play of a first game independently of any other electronic gaming machine connected to the EGM-managing network, the one or more internal components including a touchscreen display device, a memory and a communication interface within the housing, wherein the memory stores player credit and the communication interface receives data signals from the one or more internal components, the data signals including an active session data signal corresponding to an outcome of the first game being undetermined and an inactive session data signal corresponding to an outcome of the first game being determined, the system comprising:
a game transaction controller including a processor, a data communication device, and a data storage device, the data storage device including executable code, wherein the data communication device is in communication with the communication interface, the EGM-managing network and a random number generator, the processor executing the executable code to enable the game transaction server to:
a) responsive to detecting an inactive session data signal, actuate (i) a timer, wherein the timer counts down a preset time period, (ii) and a transmission of a second game display to the communication interface for display on the touchscreen display device, the second game display including the timer and a touch-sensitive portion for wagering on the second game;
b) responsive to detecting a data signal received by the communication interface from the one or more internal components relating to the touch-sensitive portion being touched prior to the end of the preset time period, store the unique identification code from each electronic gaming machine of the plurality of electronic gaming machines from which the data signal is detected in the data storage device with a group of unique identification codes associated with an instance of the second game;
c) transmit a data signal instruction to the EGM-managing network to deduct an amount of credit from the player credit relating to the wager, the data signal instruction including the unique identification code from which the data signal is detected;
d) responsive to validating the wager by detecting a data signal generated by the one or more internal components relating to the amount of credit being deducted, actuate the random number generator to randomly select a winning unique identification code from the group of unique identification codes associated with the instance of the second game;
e) transmit a data signal instruction to the EGM-managing network to credit an award amount to the player credit of the electronic gaming machine having the winning unique identification code, the data signal instruction including the winning unique identification code;
f) display the winning unique identification code and award amount on the second game display;
g) determine a location of the electronic gaming machine having the winning unique identification code through communication with the EGM-managing network; and
h) display the location of the electronic gaming machine having the winning unique identification code on the second game display.

2. A method of securely enabling a second game through a plurality of electronic gaming machines connected in an EGM-managing network, wherein each electronic gaming machine of the plurality of electronic gaming machines is associated with a unique identification code and includes a housing and one or more internal components mounted within the housing being configured to enable play of a first game independently of any other electronic gaming machine connected to the EGM-managing network, the one or more internal components including a touchscreen display device, a memory and a communication interface within the housing, wherein the memory stores player credit and the communication interface receives data signals from the one or more internal components, the data signals including an active session data signal corresponding to an outcome of the first game being undetermined and an inactive session data signal corresponding to an outcome of the first game being determined, and wherein a game transaction controller is provided, the game transaction controller including a processor, a data communication device, and a data storage device, the data storage device including executable code, wherein the data communication device is in communication with the communication interface, the EGM-managing network and a random number generator, the processor executing the executable code to enable the method comprising the steps of:
a) responsive to detecting an inactive session data signal, actuating (i) a timer, wherein the timer counts down a preset time period, (ii) and a transmission of a second game display to the communication interface for display on the touchscreen display device, the second game display including the timer and a touch-sensitive portion for wagering on the second game;
b) responsive to detecting a data signal received by the communication interface from the one or more internal components relating to the touch-sensitive portion being touched prior to the end of the preset time period, storing the unique identification code from each electronic gaming machine of the plurality of electronic gaming machines from which the data signal is detected in the data storage device with a group of unique identification codes associated with an instance of the second game;
c) transmitting a data signal instruction to the EGM-managing network to deduct an amount of credit from the player credit relating to the wager, the data signal instruction including the unique identification code from which the data signal is detected;
d) responsive to validating the wager by detecting a data signal generated by the one or more internal components relating to the amount of credit being deducted, actuating the random number generator to randomly select a winning unique identification code from the group of unique identification codes associated with the instance of the second game;
e) transmitting a data signal instruction to the EGM-managing network to credit an award amount to the player credit of the electronic gaming machine having the winning unique identification code, the data signal instruction including the winning unique identification code;
f) displaying the winning unique identification code and award amount on the second game display;
g) determining a location of the electronic gaming machine having the winning unique identification code through communication with the EGM-managing network; and
h) displaying the location of the electronic gaming machine having the winning unique identification code on the second game display.

3. An improvement to an electronic casino gaming floor system having a plurality of electronic gaming machines connected in an EGM-managing network, wherein each electronic gaming machine of the plurality of electronic gaming machines is associated with a unique identification code and includes a housing and one or more internal components mounted within the housing being configured to enable play of a first game independently of any other electronic gaming machine connected to the EGM-managing network, the one or more internal components including a touchscreen display device, a memory and a communication interface within the housing, wherein the memory stores player credit and the communication interface receives data signals from the one or more internal components, the data signals including an active session data signal corresponding to an outcome of the first game being undetermined and an inactive session data signal corresponding to an outcome of the first game being determined, the improvement enabling a second game, the improvement comprising:
a game transaction controller including a processor, a data communication device, and a data storage device, the data storage device including executable code, wherein the data communication device is in communication with the communication interface, the EGM-managing network and a random number generator, the processor executing the executable code to enable the game transaction server to:
a) responsive to detecting an inactive session data signal, actuate (i) a timer, wherein the timer counts down a preset time period, (ii) and a transmission of a second game display to the communication interface for display on the touchscreen display device, the second game display including the timer and a touch-sensitive portion for wagering on the second game;
b) responsive to detecting a data signal received by the communication interface from the one or more internal components relating to the touch-sensitive portion being touched prior to the end of the preset time period, store the unique identification code from each electronic gaming machine of the plurality of electronic gaming machines from which the data signal is detected in the data storage device with a group of unique identification codes associated with an instance of the second game;
c) transmit a data signal instruction to the EGM-managing network to deduct an amount of credit from the player credit relating to the wager, the data signal instruction including the unique identification code from which the data signal is detected;
d) responsive to validating the wager by detecting a data signal generated by the one or more internal components relating to the amount of credit being deducted, actuate the random number generator to randomly select a winning unique identification code from the group of unique identification codes associated with the instance of the second game;
e) transmit a data signal instruction to the EGM-managing network to credit an award amount to the player credit of the electronic gaming machine having the winning unique identification code, the data signal instruction including the winning unique identification code;
f) display the winning unique identification code and award amount on the second game display;
g) determine a location of the electronic gaming machine having the winning unique identification code through communication with the EGM-managing network; and
h) display the location of the electronic gaming machine having the winning unique identification code on the second game display.
